(19) United States
(12) Patent Application Publication
(10) Pub. No.: US 2019/0165514 A1
(43) Pub. Date: May 30, 2019

(54) Cap

(71) Applicant: Tyco Electronics Japan G.K., Kanagawa (JP)

(72) Inventors: Hiroki Kondo, Kanagawa (JP); Fumito Nagashima, Kanagawa (JP); Jyo Naito, Kanagawa (JP); Yosuke Tanaka, Kanagawa (JP)

(73) Assignee: Tyco Electronics Japan G.K., Kanagawa (JP)

(21) Appl. No.: 16/202,658

(22) Filed: Nov. 28, 2018

(30) Foreign Application Priority Data
Nov. 30, 2017 (JP) 2017-230296

(51) Int. Cl. H01R 13/627; H01R 13/53; H01R 13/52

(52) U.S. Cl. CPC H01R 13/6278; H01R 13/5213; H01R 13/53

(57) ABSTRACT

A cap for attachment to a fastener comprises a securing base removably supported on a neck portion of the fastener, a hinge portion connected to the securing base, and a covering portion connected to the hinge portion. The securing base has a plurality of elastic beams defining a head portion passageway receiving a head portion of the fastener. The neck portion has a smaller diameter than a largest diameter of the head portion. The elastic beams are elastically deformed by the head portion during passage of the head portion through the head portion passageway. The covering portion is movable between an open position exposing the head portion and a covering position covering the head portion and overlapping with the securing base.

### CROSS-REFERENCE TO RELATED APPLICATION

This application claims the benefit of the filing date under 35 U.S.C. § 119(a)-(d) of Japanese Patent Application No. 2017-230296, filed on Nov. 30, 2017.

### FIELD OF THE INVENTION

The present invention relates to a cap and, more particularly, to a cap for covering a head portion of a fastener.

### BACKGROUND

A high-voltage connector is connected with an end of a high-voltage line and fastened to a device with a fastener, such as a bolt. It is necessary to prevent the fastener from coming off accidentally, which could result in the high-voltage connector coming off the device, potentially resulting in an accident such as an electric shock of a worker touching an energized part. The fastener is therefore retained by a retainer such as a C-ring, and has a structure whereby the fastener can only be removed with an intentional detachment by the worker. In addition, in order to prevent the worker from detaching accidentally in a hot-line state where high voltage is applied to the high-voltage line, a cap in a noticeable color is placed over a head portion of the fastener.

Japanese Patent Application No. 2015-17625A discloses a high-voltage connector secured with a bolt. The high-voltage connector has a bolt cap provided with a securing basal member for being secured with the bolt, a covering cap for covering the head portion of the bolt, and a hinge for connecting the secured basal member and the covering cap together and allowing the covering cap to turn.

The cap placed over the head portion of the fastener is often made of resin, and therefore the hinge, for example, is sometimes torn off or otherwise broken. In the case of a bolt cap having the structure in JP 2015-17625A, the bolt cap cannot be replaced without detaching the bolt fastening the high-voltage connector to the device. Because it is necessary to ensure that electrical shocks are prevented when the bolt is detached, operation of the device must be stopped to replace the bolt cap by stopping the application of high voltage to the high-voltage line, which results in a more time-intensive repair operation.

### SUMMARY

A cap for attachment to a fastener comprises a securing base removably supported on a neck portion of the fastener, a hinge portion connected to the securing base, and a covering portion connected to the hinge portion. The securing base has a plurality of elastic beams defining a head portion passageway receiving a head portion of the fastener. The neck portion has a smaller diameter than a largest diameter of the head portion. The elastic beams are elastically deformed by the head portion during passage of the head portion through the head portion passageway. The covering portion is movable between an open position exposing the head portion and a covering position covering the head portion and overlapping with the securing base.

### BRIEF DESCRIPTION OF THE DRAWINGS

The invention will now be described by way of example with reference to the accompanying Figures, of which:

FIG. 1 is a perspective view of a high-voltage connector according to an embodiment;

FIG. 2 is a detailed perspective view of a portion R1 of the high-voltage connector shown in FIG. 1;

FIG. 3 is a side view of the high-voltage connector;

FIG. 4 is a sectional side view of the high-voltage connector attached to a mating connector;

FIG. 5 is a detailed sectional side view of a portion R2 of the high-voltage connector shown in FIG. 4;

FIG. 6 is a perspective view of a bolt and a cap of the high-voltage connector before attachment of the cap to the bolt;

FIG. 7 is a perspective view of the cap attached to the bolt with the cap in an open position; and

FIG. 8 is a perspective view of the cap attached to the bolt with the cap in a covering position over a head portion of the bolt.

### DETAILED DESCRIPTION OF THE EMBODIMENT(S)

Embodiments of the present invention will be described hereinafter in detail with reference to the attached drawings, wherein like reference numerals refer to the like elements. The present invention may, however, be embodied in many different forms and should not be construed as being limited to the embodiments set forth herein; rather, these embodiments are provided so that the disclosure will be thorough and complete and will fully convey the concept of the invention to those skilled in the art.

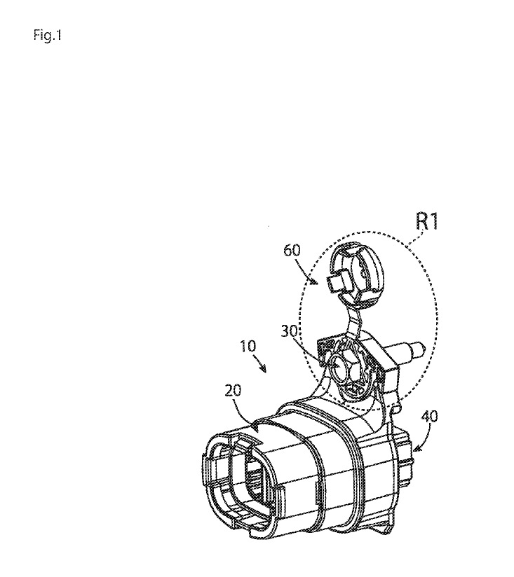

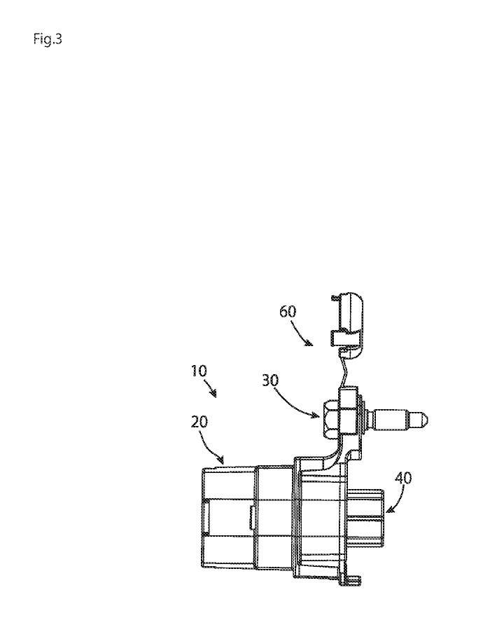

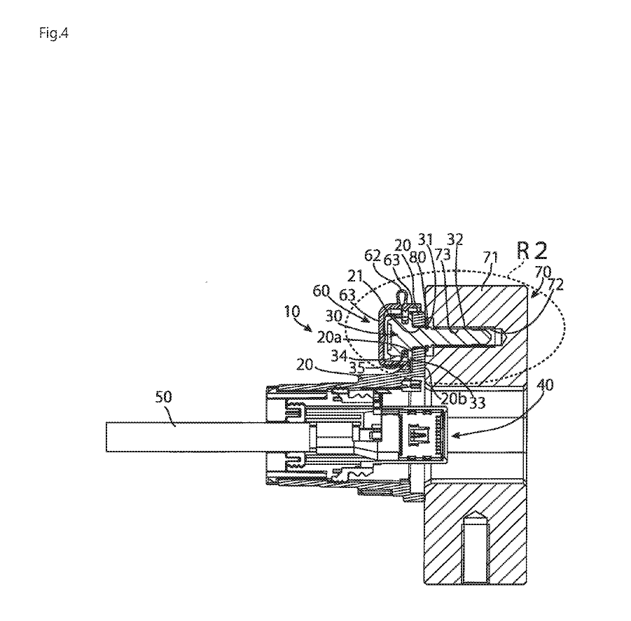

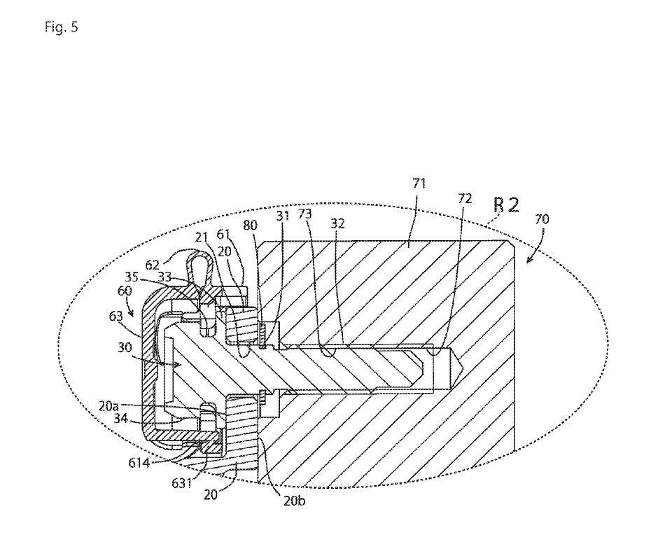

A high-voltage connector 10 according to an embodiment is shown in FIGS. 1, 3, and 4. The high-voltage connector 10 includes an aluminum die-cast case 20, a bolt 30, a contact 40, a high-voltage line 50 connected to the contact 40, and a cap 60. The high-voltage connector 10 is secured to a housing 71 of a mating device 70 with the bolt 30, as shown in FIGS. 4 and 5. The contact 40 is connected to a contact of the mating device 70.

As shown in FIGS. 4 and 5, an fastening passageway 21 into which the bolt 30 is inserted is formed in the aluminum die-cast case 20. The bolt 30 is inserted into the fastening passageway 21 from a surface 20a side of the case 20. A retaining ring positioning groove 31 and an externally-threaded portion 32 are provided in a section of the bolt 30 projecting from a back face 20b side of the case 20. A retaining ring 80 is positioned in the retaining ring positioning groove 31. The retaining ring 80 prevents the bolt 30 from being removed from the surface 20a side of the case 20.

The bolt 30, as shown in FIGS. 4 and 5, is screwed into a screw hole 72 of the housing 71 having an internally-threaded portion 73. The externally-threaded portion 32 of the bolt 30 and the internally-threaded portion 73 inside the screw hole 72 of the housing 71 are screwed together, and thereby the high-voltage connector 10 is attached to the mating device 70.

The high-voltage connector 10 and the mating device 70 may be, respectively, referred to as a first fastened body and a second fastened body. The bolt 30 may be referred to as a fastener. The retaining ring positioning groove 31 and the externally-threaded portion 32 provided in the bolt 30 may be referred to, respectively, as a retaining portion and a fastening portion. Further, the retaining ring 80 may be referred to as a retainer.

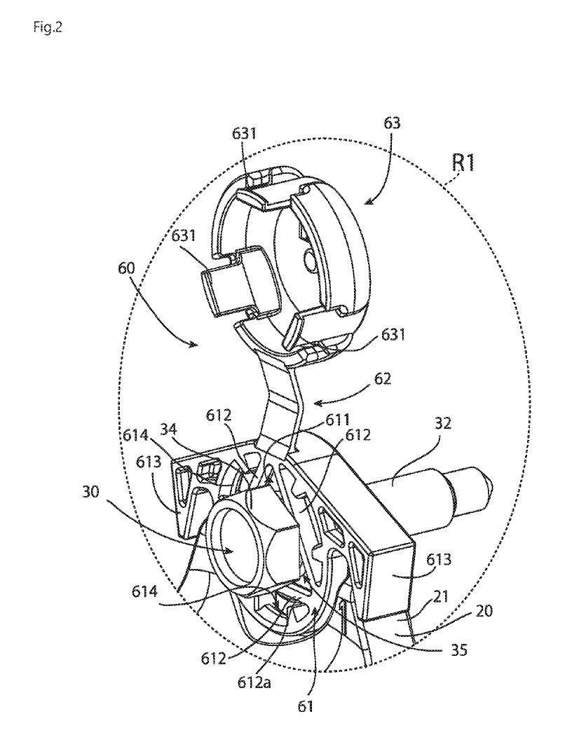

The bolt 30, as shown in FIGS. 4 and 5, includes a flange portion 33, a head portion 34, and a neck portion 35 on a surface 20a side of the bolt 30 inserted into the fastening hole 21 of the case 20. The flange portion 33 has a larger diameter than the fastening hole 21 and abuts against a portion around the fastening hole 21 of the surface 20a of the case 20. The head portion 34 forms an end of the bolt 30 on the surface 20a side of the case 20 for receiving a force from a tool for turning the bolt 30. The head portion 34 of the bolt 30 in the shown embodiment has a substantially hexagonal-prismatic shape, as also shown in FIG. 2. The head portion 34 is provided separately from the flange portion 33; the neck portion 35 having a smaller diameter than the largest diameter of the head portion 34 is disposed between the head portion 34 and the flange portion 33. A securing base 61 of the cap 60 is removably supported on the neck portion 35 as described in greater detail below.

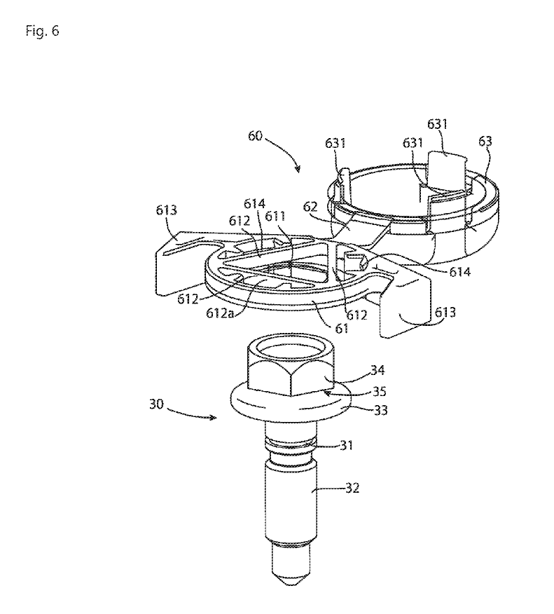

The cap 60, as shown in FIGS. 2 and 6-8, includes the securing base 61, a hinge portion 62, and a covering portion 63. The cap 60 is made of resin in a noticeable color, for example, orange. The securing base 61 is supported on the neck portion 35 of the bolt 30. The hinge portion 62 connects the securing base 61 and the covering portion 63. The covering portion 63 is a portion for exposing or covering the head portion 34 of the bolt 30 in an overlapping manner with the securing base 61. The covering portion 63 is movable between an open position exposing the head portion 34 and a covering position covering the head portion 34.

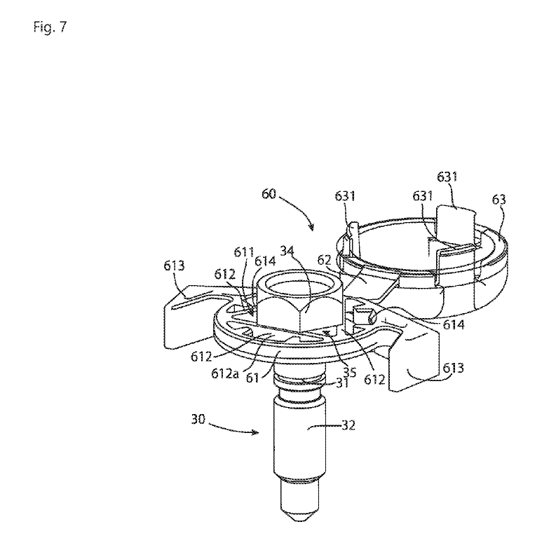

The securing base 61, as shown in FIGS. 2 and 6-8, has a plurality of elastic beams 612 defining a head portion passageway 611 that receives the head portion 34 of the bolt 30. In the shown embodiment, the securing base 61 has three elastic beams 612. When the cap 60 is attached to the bolt 30, the head portion 34 of the bolt 30 is pushed into the head portion passageway 611. The head portion passageway 611 has a size such that the head portion 34 of the bolt 30 can only pass through the head portion passageway 611 when an external force is applied to the bolt 30. When the head portion 34 of the bolt 30 is pushed into the head portion passageway 611, the elastic beams 612 are elastically deflected and stretched outward, thereby allowing the passage of the head portion 34. Then, once the head portion 34 passes through the head portion passageway 611 and the elastic beams 612 reach the position of the neck portion 35 of the bolt 30, as shown in FIG. 7, the elastic beams 612 are released from the deflection and restored to their original shapes. The elastic beams 612 then enter the neck portion 35 of the bolt 30 and the securing base 61 of the cap 60 is supported on and secured to the bolt 30.

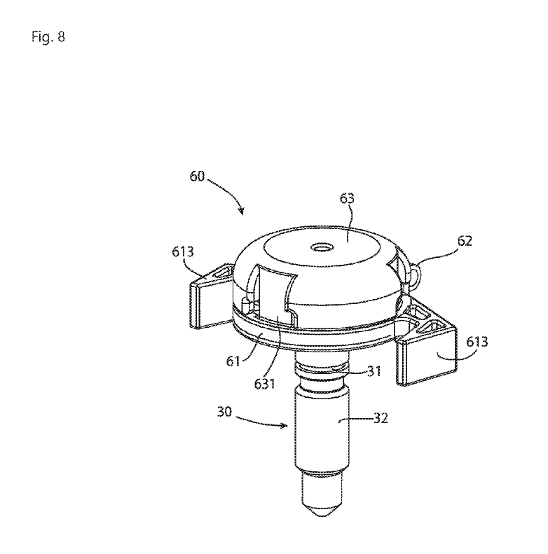

The hinge portion 62 connects the securing base 61 and the covering portion 63 together such that the covering portion 63 can overlap with the securing base 61 in the covering position, as shown in FIGS. 2 and 6-8. The covering portion 63 overlaps with the securing base 61 with the securing base 61 supported on the neck portion 35 of the bolt 30. The covering portion 63 is positioned over the head portion 34 of the bolt 30 to cover the head portion 34 in the covering position, as shown in FIG. 8.

The securing base 61 is removably supported on the neck portion 35 of the bolt 30 by the elastic beams 612. When the cap 60 is broken, for example, the hinge portion 62 is torn off, the cap 60 can be replaced by detaching the securing base 61 of the broken cap 60 from the bolt 30 without detaching the bolt 30.

The securing base 61 has a pair of arm portions 613, as shown in FIGS. 2 and 6-8. The pair of arm portions 613 have a shape whereby the pair of arm portions 613 abut the case 20 and hold a bolt mounting portion 21 of the case 20 from both sides. The pair of arm portions 613 may be referred to as an anti-rotation portion. When the high-voltage connector 10 is attached to the mating device 70 or detached from the mating device 70, the bolt 30 is rotated by a tool. At this time, if, following the rotation of the bolt 30, the cap 60 rotates together with the bolt 30 around an axis of rotation of the bolt 30, the cap 60 may hinder the attachment/detachment work. In addition, such co-rotation may also cause the breakage of the cap 60. The pair of arm portions 613 are so provided in the securing base 61 as to interfere with the case 20 in a rotational direction, preventing the cap 60 from rotating.

In the embodiment shown in FIGS. 2, 6, and 7, the covering portion 63 of the cap 60 has three hook portions 631 disposed on an outer periphery of the covering portion 63. Corresponding to these hook portions 631, hook receiving portions 614 for receiving the hook portions 631 and being caught by the hook portions 631 are recesses provided at three locations corresponding to the three hook portions 631 on an inner periphery of the securing base 61 of the cap 60. The hook portion 631 and the hook receiving portion 614 may be respectively referred to as a catching portion and a caught portion. Once the covering portion 63 is moved over the head portion 34 of the bolt 30 by rotating the covering portion 63 about the hinge portion 62 as a turning axis, the hook portions 631 are caught by the hook receiving portions 614. The covering portion 63 is thereby kept in the covering position over the head portion 34 of the bolt 30.

In another embodiment, a structure whereby the covering portion 63 catches the head portion 34 of the bolt 30 is also conceivable. However, if the covering portion 63 catches the head portion 34 of the bolt 30, it is necessary to shape the covering portion 63 to be adapted to a size or shape of the head portion 34, which may vary between bolts 30. In addition, the head portion 34 of the bolt 30 may also be deformed, though not to an unusable degree, by receiving a force from the tool for turning the bolt 30.

In the shown embodiment, the covering portion 63 catches the securing base 61, and even with some difference in size or shape or some deformation of the head portion 34, the cap 60 of the same type can be used. In addition, because the covering portion 63 catches the securing base 61, a catching strength of the covering portion 63 does not depend on the bolt 30 but is adjusted by the cap 60 itself.

The hinge portion 62 connects the covering portion 63 to a side of the securing base 61 opposite the head portion passageway 611 from one elastic beam 612a of the plurality of elastic beams 612, as shown in FIGS. 2, 6, and 7. The hinge portion 62 has a structure whereby the covering portion 63 is folded between the open position and the covering position around a folding axis parallel with the one elastic beam 612a.

The covering portion 63 covering the head portion 34 of the bolt 30 and catching the securing base 61 can be positioned in the open position to uncover the head portion 34, as shown in FIGS. 2 and 7. When a force is applied to open the covering portion 63, the force reaches the securing base 61 caught by the covering portion 63. That is, a force directed to remove the securing base 61 from the bolt 30 is applied to the securing base 61. However, the hinge portion 62 of the cap 60 of the present embodiment is provided on the opposite side across the head portion passageway 611 from the one elastic beam 612a, and has the structure whereby the covering portion 63 is rotated around the folding axis parallel with the one elastic beam 612a. Therefore, when the force is applied to open the covering portion 63, a force directed to make the one elastic beam 612a secure deeply into the bottom of the neck portion 35 of the bolt 30 is also applied to the securing base 61. The force intended to open the covering portion 63 causes the force directed to remove the securing base 61 from the bolt 30 to be applied to the securing base 61 on the whole, but simultaneously causes the force directed to make the one elastic beam 612a secure more deeply into the neck portion 35 of the bolt 30. Because the one elastic beam 612a secures into the neck portion 35 of the bolt 30, the securing base 61 is prevented from coming off from the bolt 30.

In the shown embodiment, three elastic beams 612 define the head portion passageway 611 in the securing base 61. The number of elastic beams 612 is not required to be three, and in other embodiments, could be two or four or more. The number of elastic beams 612 is determined in light of the shape, size, or the like, of the head portion 34 of the bolt 30. In the case of the bolt 30 having the head portion 34 with a substantially hexagonal-prismatic shape as in the shown embodiment, the head portion passageway 611 has a triangular shape with three elastic beams 612.

An exemplary application of the present invention to the shown high-voltage connector 10 has been described herein. However, the cap 60 is not limited to the application of a high-voltage connector 10. The cap 60 is widely applicable where it is necessary to fasten a first fastened body equivalent to the high-voltage connector 10 to a second fastened body that is a fastening mate with a fastener such as a bolt and cover a head portion of the fastener. Furthermore, in the shown embodiment, the cap 60 is used with a bolt 30 that attaches the high-voltage connector 10 to the mating device 70. In other embodiments, the cap 60 is widely applicable to a case where the fastened bodies are fastened together with a screw tightened with a driver, a hexagon socket head cap bolt or screw tightened with a hexagonal bar wrench, or any other fasteners having head portions.

What is claimed is:

1. A cap for attachment to a fastener, comprising:
a securing base removably supported on a neck portion of the fastener, the securing base having a plurality of elastic beams defining a head portion passageway receiving a head portion of the fastener, the neck portion has a smaller diameter than a largest diameter of the head portion and the elastic beams are elastically deformed by the head portion during passage of the head portion through the head portion passageway;
a hinge portion connected to the securing base; and
a covering portion connected to the hinge portion and movable between an open position exposing the head portion and a covering position covering the head portion and overlapping with the securing base.

2. The cap of claim 1, wherein the covering portion has a catching portion engaging the securing base when the covering portion is in the covering position.

3. The cap of claim 2, wherein the securing base has a caught portion engaging the catching portion when the covering portion is in the covering position.

4. The cap of claim 3, wherein the catching portion is a hook portion extending from an outer periphery of the covering portion

5. The cap of claim 4, wherein the caught portion is a recess disposed on an inner periphery of the securing base.

6. The cap of claim 1, wherein the fastener is rotated to fasten a first fastened body to a second fastened body and the securing base has an anti-rotation portion contacting the first fastened body and preventing rotation of the securing base around an axis of rotation of the fastener.

7. The cap of claim 6, wherein the anti-rotation portion is a pair of arm portions extending from opposite sides of the securing base.

8. The cap of claim 1, wherein the hinge portion connects the covering portion to a side of the securing base opposite the head portion passageway from one elastic beam of the plurality of elastic beams.

9. The cap of claim 8, wherein the covering portion is moved between the open position and the covering position about a folding axis that is parallel with the one elastic beam of the plurality of elastic beams.

10. A high-voltage connector, comprising:
a case having a surface side, a back face side opposite the surface side, and a fastening passageway extending through the case from the surface side to the back face side;
a fastener inserted into the fastening passageway from the surface side of the case, the fastener having a fastening portion projecting from the back face side of the case for fastening the connector to a mating device, a flange portion abutting against a portion of the surface side around the fastening passageway, a head portion forming an end of the fastener on the surface side of the case and separated from the flange portion, and a neck portion disposed between the head portion and the flange portion and having a smaller diameter than a largest diameter of the head portion; and
a cap including a securing base removably supported on the neck portion, the securing base having a plurality of elastic beams defining a head portion passageway receiving the head portion, the elastic beams are elastically deformed by the head portion during passage of the head portion through the head portion passageway, a hinge portion connected to the securing base, and a covering portion connected to the hinge portion and movable between an open position exposing the head portion and a covering position covering the head portion and overlapping with the securing base.

11. The high-voltage connector of claim 10, wherein the covering portion has a catching portion engaging the securing base when the covering portion is in the covering position.

12. The high-voltage connector of claim 11, wherein the securing base has a caught portion engaging the catching portion when the covering portion is in the covering position.

13. The high-voltage connector of claim 10, wherein the fastener is rotated to fasten the connector to the mating device and the securing base has an anti-rotation portion contacting the case and preventing rotation of the securing base around an axis of rotation of the fastener.

14. The high-voltage connector of claim 13, wherein the anti-rotation portion is a pair of arm portions extending from opposite sides of the securing base, the arm portions abut the case and hold opposite sides of a bolt mounting portion of the case.

15. The high-voltage connector of claim 10, wherein the hinge portion connects the covering portion to a side of the securing base opposite the head portion passageway from one elastic beam of the plurality of elastic beams.

16. The high-voltage connector of claim 15, wherein the covering portion is moved between the open position and the covering position about a folding axis that is parallel with the one elastic beam of the plurality of elastic beams.
